(19) United States
(12) Patent Application Publication
(10) Pub. No.: US 2011/0078698 A1
(43) Pub. Date: Mar. 31, 2011

(54) METHOD FOR RECONCILING MAPPINGS IN DYNAMIC/EVOLVING WEB-ONTOLOGIES USING CHANGE HISTORY ONTOLOGY

(76) Inventors: Sungyoung Lee, Seongnam-si (KR); Young-Koo Lee, Seo-gu (KR); Hyoungil Kim, Seongnam-si (KR); Manhyung Han, Goyang-si (KR); Asad Masood Khattak, Yongin-si (KR)

(21) Appl. No.: 12/576,342

(22) Filed: Oct. 9, 2009

(30) Foreign Application Priority Data
Sep. 29, 2009 (KR) 10-2009-0092274

(51) Int. Cl. G06F 9/50

(52) U.S. Cl. 718/104

(57) ABSTRACT

The present invention is directed to reconciliation/reengineering of mappings in dynamic/evolving ontologies. Mappings are established among different ontologies for resolving the terminological and conceptual incompatibilities and support information exchange. As ontology evolves from one consistent state to another consistent state; this consequently makes the existing mappings of the domain ontology with other ontologies unreliable and staled, so mapping evolution is required. The present invention uses Change History Log of ontology changes to drastically reduce the time required for (re)establishing mappings among ontologies, achieving higher accuracy, and eliminating staleness in mappings. It is valid for more than two ontologies with local, centralized, and distributed Change History Log.

### BACKGROUND OF THE INVENTION

1. Field of the Invention

This invention relates to reconciliation/reengineering of mappings in dynamic/evolving ontologies.

2. Description of the Related Art

Currently different research groups are working on ontology matching and mapping. They have developed systems such as FALCON [Hu, W. and Ou, Y. “Falcon-A O: A practical ontology matching system.” Journal of Web Semantics. 6, 3 (September 2008), 237-239. DOI=http://dx.doi.org/10.1016/j.websem. 2008], H-Match [S. Castano, A. Ferrara, and S. Montanelli “Matching ontologies in open networked systems: Techniques and applications.” Journal on Data Semantics (JoDS), vol. V, pp. 25-63, 2006], and MAFRA [Maedche, A., Motik, B., Silva, N. and Volz, R. “MAFRA—A MApping FRAmework for Distributed Ontologies.” In Proceedings of the 13^{th} international Conference on Knowledge Engineering and Knowledge Management ontologies and the Semantic Web, pp 235-250, London, 2002]. The concept of Change Log was presented by different researchers but major work in this regard is done by Y. David Liang in [Y. D. Liang, “Enabling Active Ontology Change Management within Semantic Web-based Applications.” Mini PhD Thesis, University of Southampton, 2006] where some researchers discussed its contents and few discussed its structure.

FALCON, H-Match, and MAFRA present overall infrastructure for Semantic Web ontologies learning, matching, mapping, and aligning As an infrastructure for Semantic Web ontologies, it is extensively used by the semantic web community for applications such as aligning and learning ontologies, and ultimately for knowledge discovery. These are the mostly used tools for web ontology matching and mappings that are expressed in RDF(S) and/or OWL. Their accuracy for matching and mapping of ontologies are very good, but they also takes much time in establishment of alignment like other algorithm plus each time the ontology is updated the complete process of matching and mapping is needs to be initiated again to reestablish the mappings among the ontologies. This consumes lot of time as the changes might be very simple in type and less in numbers.

Y. David Liang presented the concept of Log Ontology. Multiple ontology changes are logged in it and are used for query reformulation over the evolved ontology. Log Ontology does not store all ontology changes and it is developed for one specific purpose of query reformulation. In this Log Ontology, it is hard to differentiate the sequence of ontology changes, changes of certain time interval, and changes belonging to different ontology versions.

### SUMMARY OF THE INVENTION

Different algorithms have been proposed by the research community for the purpose of ontology mapping having relatively high accuracy. All the algorithms are designed to deliver the complete mapping starting from the scratch and considering all the resources in the ontology. The present invention mainly focuses on the problem of reestablishment of ontology mapping on evolving ontologies. This invention has been made to eliminate the problems (accuracy, and time efficiency) of mapping algorithms discussed above by extending them to incorporate the use of Change History Log. The use of Change History Log in ontology matching/mapping helps to accomplish better accuracy of match results. Further, it supports for reconciliation of ontology mappings in dynamic/evolving web ontologies to overcome the staleness problem of mappings. The Change History Log is based on Change History Ontology to keep track of all the ontology changes. During reconciliation of ontology mapping, what we need to do is to update the out of date mappings only. The reconciliation of mapping only for the changed resources (accessed from Change History Log) in ontologies saves time and resources.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating the realization and participation pattern of ontology change in Change History Ontology according to an embodiment of the present invention.

FIG. 2 is a diagram illustrating reification of time-indexed participation in method for reconciling mappings according to an embodiment of the present invention.

FIG. 3 illustrates the method for reconciling mappings in dynamic/evolving web-ontologies using change history ontology according to an embodiment of the present invention.

### DETAILED DESCRIPTION OF THE PREFERRED EMBODIMENT

The present invention for reconciliation of mapping in dynamic/evolving ontologies is more accurate, time efficient, and also eliminates staleness from the mappings. It is based on the concept of Change History Log that contains all the ontology changes that happen during evolution. So basically the present invention has two main components; 1) Change History Log, and 2) Reconciliation of Mappings.

Number of changes, ranging from concepts to properties, can affect the ontology. Understanding of change types is necessary to correctly handle explicit and implicit change requirements. For that matter, Change History Ontology (CHO) has been designed to capture ontology change requirements and to keep track of the change history. [Asad Masood Khattak, Khalid Latif, Sharifullah Khan, Nabeel Ahmed, “Managing Change History in Web Ontologies,” Fourth International Conference on Semantics, Knowledge and Grid, pp. 347-350, China, 2008]

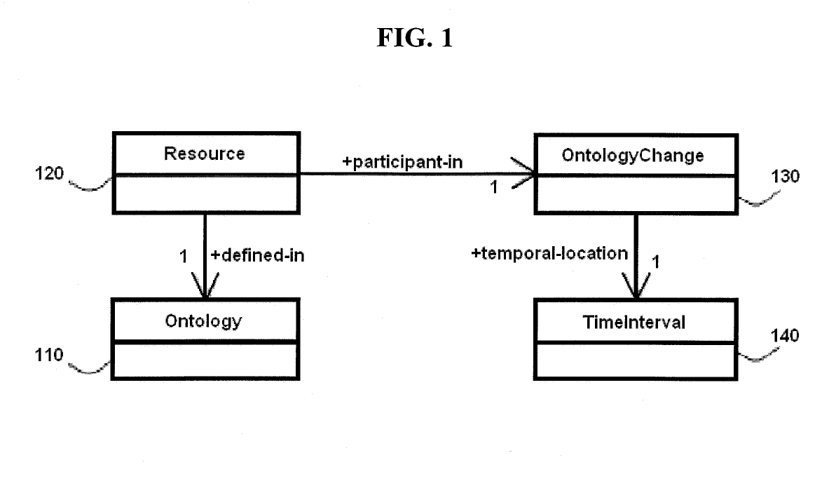

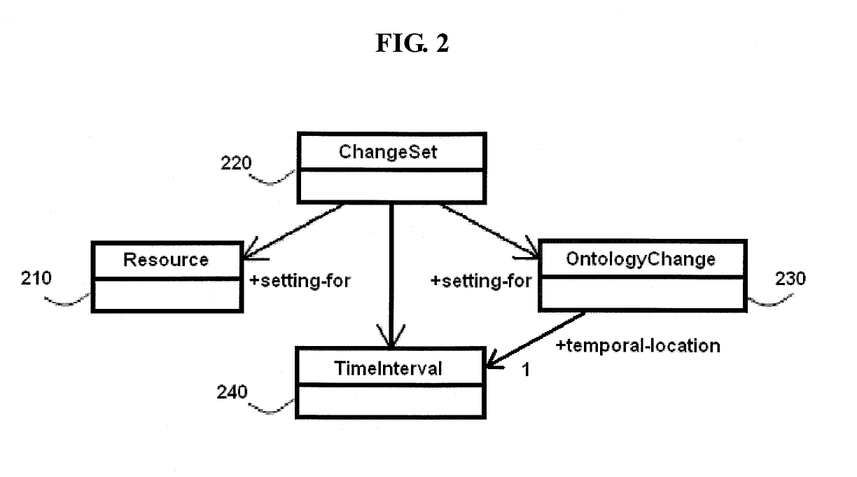

The core elements of CHO are OntologyChange and ChangeSet classes. As shown by FIG. 1, the OntologyChange 130 class have sub-class as AtomicChange that represent all the class and property level changes at atomic level. On the other hand the ChangeSet 220 bundles all the changes of specific time interval in a coherent manner shown in FIG. 2. The ChangeSet 220 is responsible for managing all the ontology changes and arranges them in time-indexed fashion. This time indexing also classifies the ChangeSet 220 as Instant type and Interval type. Instant type ChangeSet holds only one change occurred at some time instant, while the Interval type ChangeSet holds the changes occurred in a starched time interval.

Corresponding to the CRUD interfaces in databases (excluding read), there are three categories in the proposed ontology representing the operations or the change types: Create (such as ClassAddition and PropertyAddition), Update (such as ClassRenaming and PropertyRenaming), and Delete (such as ClassDeletion and PropertyDeletion). There are two categories in the ontology to represent different components of the ontology being subject to change. Included in these categories are ClassChange and PropertyChange. Based on the above mentioned categories instances of class OntologyChange are derived, represented with the symbol Δ, using the following axioms:

R_{Δ}≡ClassChange␣PropertyChange

Δ≡R_{Δ} [symbol] ∀changeType.(Create␣Update␣Delete) [symbol] ∃changeAgent.(Person␣SoftwareAgent) [symbol] =1changeReason

where R_{Δ} is a changed resource and that resource can be a class or a property which is termed above as ClassChange or PropertyChange, U is used for “OR”, [symbol] is used for “AND” and Δ represent small part. In this, it represent the change only not everything. ∀ is used for “FOR ALL”, ∃ is used for “THERE EXIST SOME” and =1 used for “COMPULSORY ONE”.

For example the following snippet represents the class addition scenario.

Code 1, Transaction Class Addition

log:Transaction_ClassAddition_20987

| | |
|---|---|
| a | cho:ClassAddition; |
| cho:hasChangedTarget | doc:Transactions; |
| cho:isSubClassOf | doc:Documentation; |
| cho:hasTimeStamp | 1224527071000; |
| cho:isPartOf | log:ChangeSet_2008-07-17_22_30_58. |

In the above snippet log is prefix for Change History Log, cho is a prefix for Change History Ontology, and doc is a prefix for Documentation ontology. The above snippet depicts an instant of ClassAddition class which is defined as a sub-class of ClassChange.

ClassAddition [symbol] ClassChange [symbol] ∃changeType.Create

where [symbol] is used for “SUBSET”, [symbol] is used for “AND” and ∃ is used for “THERE EXIST SOME”.

With reference to relational databases, the methodology of the present invention recons on logging technique to persistently store the changes. This later on helps undo/redo, ontology recovering, query reformulation, temporal traceability of ontology changes, and reconciliation of ontology mappings. The changes are preserved in time-indexed manner in a triple store using the schema provided by CHO. Upon a request for any of the above mentioned purpose, this Change History Log(CHL) containing all the changes is accessed for the required changes. Each entry in the log is an instance of either ChangeSet class 220 or OntologyChange class 230 from the CHO. The log also preserves the provenance information about the change, such as who made these changes and when; and also what was the reason for these changes.

The use of ontology is not restricted to only local use, but they may be centralized or even distributed among different remote nodes, so the same goes for CHL. CHL can also be used in all the three contexts (i.e. local CHL, centralized CHL, and distributed CHL). The application of CHL are wide spread such as ontology change management and understanding for semantic of change, undo/redo of ontology changes, ontology recovery, temporal traceability of ontology changes, visualization of ontology changes, evolving ontology, and change effects on the ontology, query reformulation for evolving ontology, and reconciliation of ontology mappings.

As discussed above, there are different algorithms available to establish mappings among two or more ontologies and some of them also have high mapping accuracy. The present invention uses the Change History Log entries for establishment and reestablishment of mappings among ontologies, which not only helps to achieve better accuracy but also takes less time to generate mappings and eliminates staleness of mappings. This approach is most suitable for ontologies of big size which have hundreds and thousands of resources for example when reconciling mappings between Google Classification [http://www.google.com/Top/Reference/Libraries/Libraryand_and_Information_Science/Technical_Services/Cataloguing/Classification/] and Wiki Classification [http://en.wikipedia.org/wiki/Taxonomic_Classification], or reconciling mappings between ACM Classification Hierarchy [http://www.acm.org/about/class/1998/] and MSC Classification Hierarchy [http://www.math.niu.edu/˜rusin/known-math/index/index.html]. The bigger the size of ontology the better and time efficient the approach is against any of the above discussed algorithms. This approach can be discussed in two categories.

In first category, the present invention uses the CHL information in the first time mapping process. This will increase the accuracy of mapping algorithm. When two or more ontologies are mapped, then information from CHL can play a vital role in it. For example, in case we map a class from ontology O₁ to a class in ontology O₂ but match is not found in O₂, CHL can be consulted which can give information about classes that might have changed, and it can have some type of match with a class from O₁. In this case we only need to extend the method for calculating the Semantic Affinity by incorporating the change information from CHL. So the modified method including parameters will be like:

$$SA ( c , Δ , {c}^{′} , {Δ}^{′} , ψ ) \{ \begin{matrix}C Resource from ontology {O}_{1} \\ Δ Change information from CHL of Ontology {O}_{1} \\ {C}^{′} Resource from Ontology {O}_{2} \\ {Δ}^{′} Change information from CHL of Ontology {O}_{2} \\ ψ User defined threshold for resource match\end{matrix}$$

where SA( ) is used for “SEMANTIC AFFINITY”.

Though this incorporation of change information from CHL in matching and mapping process will not reduce the response time but on the other hand it will have good match and map accuracy.

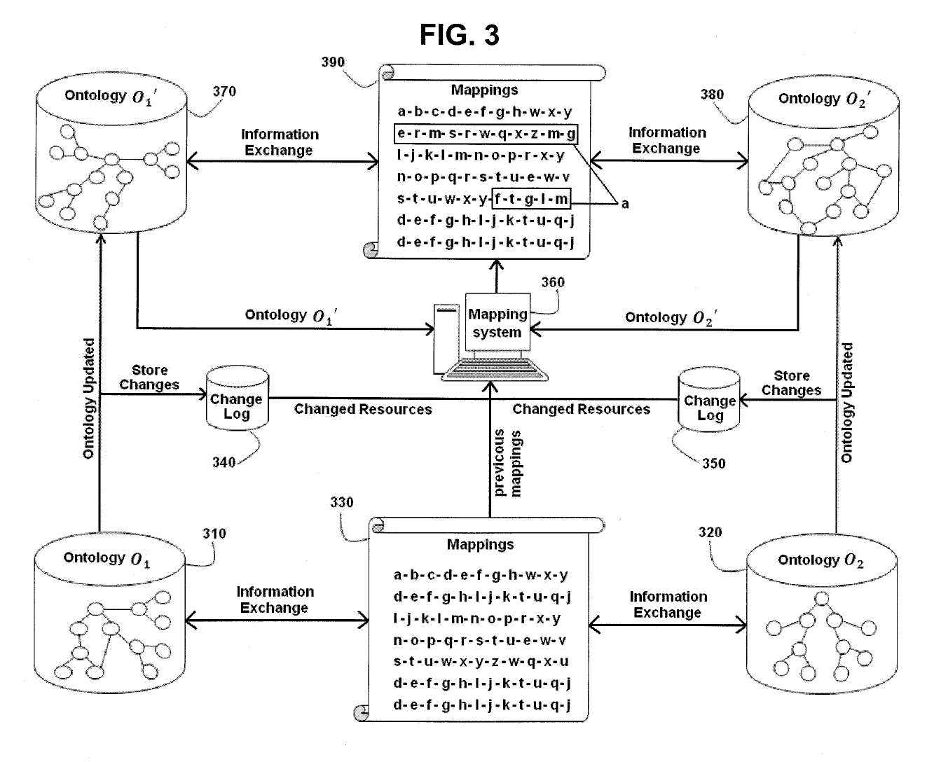

In second category, consider the scenario given in FIG. 3, where two ontologies 310, 320 are mapped and exchanges information based on the developed mappings 330. Now consider that one or both the ontologies 310, 320 are changed (evolved) to another state 370 or 380. In this case the already existing mappings 330 are of no more use as they are not reliable and also became stale in this situation. So the mappings 330 between these two ontologies also need to evolve with the evolving ontologies. To discuss this scenario we take two different cases.
1) If only one ontology evolves from one state to another, its mapping with other ontologies are not reliable as there will be definite change in the resources mapped with the other ontology. To reconcile the mappings between these ontologies, instead of completely reinitializing the mapping process from the scratch, which is a time consuming process, the present invention uses the CHL entries 340 or 350 to detect the changed resources in the evolved ontology. Then the present invention uses only these changed resources in the mapping system 360 to map it with the other ontology and simply update the previous mappings with the new one and remove the staled mapping entries from that.
2) Now consider that both the ontologies evolved from one consistent state to another state (310 to 370 and 320 to 380) as demonstrated in FIG. 3. In this case the mapping 330 also needs to evolve to accommodate the mappings for the changed resources and eliminate the staleness from the mappings. In this case, we don't need to completely reestablish the mappings between both the ontologies which is a time and resource consuming process. As given in FIG. 3, both ontologies O₁ 310 and O₂ 320 has evolved, so now to reestablish the mapping between the evolved ontologies 370 and 380 in time efficient manner and remove the staled mappings, the present invention uses the CHL entries 340 and 350 for both the ontologies to identify the changed resources from both ontologies and establish mappings for these resources and update the old mapping 330 for the changed resources and remove the unreliable (staled) mappings from the previous mappings 330.

The input for this module 360 are both the evolved ontologies O₁′ 370 and O₂′ 380, CHL entries 340 and 350 for both the ontologies Δ for ontology O₁ 310 and Δ′ for ontology O₂ 320, and previous mappings 330 between these two ontologies. So the overall method call for mapping from ontology O₁′ 370 to ontology O₂′ 380 is given below.

$$SA ( c , {c}^{′} , ψ ) \{ \begin{matrix}C Changed resource from ontology {O}_{1} , ( C ⊑ Δ ) \\ {C}^{′} Concept from Ontology {O}_{2} \\ ψ User defined threshold for resource match\end{matrix}$$

In case of mappings from ontology O₂′ 380 towards ontology O₁″ 370, the method call with the list of parameters is given below.

$$SA ( c , {c}^{′} , ψ ) \{ \begin{matrix}C Changed resource from ontology {O}_{2} , ( C ⊑ {Δ}^{′} ) \\ {C}^{′} Concept from Ontology {O}_{1} \\ ψ User defined threshold for resource match\end{matrix}$$

After the process of reconciliation, the staled part of mapping is removed from the overall mappings and is updated with the new changed mappings (a) as shown in FIG. 3 in the mappings 390. This process of reconciliation of mapping not only eliminates the staleness from the mappings but also is more time efficient and accurate for reestablishment of the mappings.

1-5. (canceled)

6. A method for reconciling mappings in dynamic/evolving web-ontologies using change history ontology, comprising the steps of:
establishing a first mapping between one or more ontologies;
identifying changed resources for each ontology when said one or more ontologies evolve; and
establishing mappings for said changed resources, updating said first mapping using said changed resources, and removing stale mappings from said first mapping to establish a second mapping.

7. The method according to claim 6, wherein said first mapping is established using a change history log that records all changes generated by evolution of ontologies.

8. The method according to claim 6, wherein said changed resources are identified using a change history log that records all changes generated by evolution of ontologies.

9. The method according to claim 7, wherein changes are recorded in said change history log in a time-indexed manner.

10. The method according to claim 8, wherein changes are recorded in said change history log in a time-indexed manner.
